(19) United States
(12) Patent Application Publication
(10) Pub. No.: US 2024/0178718 A1
(43) Pub. Date: May 30, 2024

(54) MOTOR

(71) Applicant: TOYOTA JIDOSHA KABUSHIKI KAISHA, Toyota-shi (JP)

(72) Inventors: Yasuhiro MAKIDO, Toyota-shi (JP); Yuichiro Kanada, Toyota-shi (JP); Shogo Kajimoto, Toyota-shi (JP); Hideyuki Higashi, Okazaki-shi (JP); Yukio Tsuchiya, Toyota-shi (JP)

(73) Assignee: TOYOTA JIDOSHA KABUSHIKI KAISHA, Toyota-shi (JP)

(21) Appl. No.: 18/482,210

(22) Filed: Oct. 6, 2023

(30) Foreign Application Priority Data
Nov. 29, 2022 (JP) 2022-190648

(51) Int. Cl. H02K 5/20; H02K 3/28; H02K 5/10

(52) U.S. Cl. CPC H02K 5/20; H02K 3/28; H02K 5/10

(57) ABSTRACT

A motor includes a rotor, a stator including a stator core and a coil, a housing, and a first annular member that provides sealing between a first end surface of the stator core in a direction of an axis of the stator core and an inner wall surface of the housing. The first annular member has first holes configured to be passed through by a refrigerant injected toward a first coil end of the coil, the first coil end protruding from the first end surface. The first annular member includes a first section in which at least two of the first holes are arranged in a circumferential direction of the first annular member at a first interval, and a second section in which at least two of the first holes are arranged in the circumferential direction at a second interval that is larger than the first interval.

### CROSS-REFERENCE TO RELATED APPLICATION

This application claims priority to Japanese Patent Application No. 2022-190648 filed on Nov. 29, 2022, incorporated herein by reference in its entirety.

### BACKGROUND

### 1. Technical Field

The technique disclosed in the present specification relates to a motor.

### 2. Description of Related Art

In a motor shown in U.S. patent Ser. No. 11/125,315, a stator is housed inside a housing. A plurality of injection holes is disposed in an annular member that seals an axial end surface of a stator core and an inner surface of the housing. A refrigerant can be injected from each of the injection holes toward a coil end.

### SUMMARY

Due to the temperature distribution of a coil end, a high-temperature portion may be generated in the coil end. In this case, it is desired that the cooling amount of the high-temperature portion is to be larger than the cooling amount of another portion.

A motor according to a first aspect of the present disclosure includes a rotor, a stator that includes a stator core and a coil, a housing that houses the rotor and the stator, and a first annular member that provides sealing between a first end surface of the stator core in a direction of an axis of the stator core and an inner wall surface of the housing. The first annular member has a plurality of first holes configured to be passed through by a refrigerant that is injected toward a first coil end of the coil, the first coil end protruding from the first end surface of the stator core. The first annular member includes a first section in which at least two of the first holes are arranged in a circumferential direction of the first annular member at a first interval, and a second section in which at least two of the first holes are arranged in the circumferential direction of the first annular member at a second interval that is larger than the first interval.

The refrigerant may vary and may be, for example, cooling oil. Further, the refrigerant may be a liquid such as water, or a fluid containing a gas or the like. According to the above configuration, the injection amount per unit area of the refrigerant in the first section can be made larger than the injection amount per unit area of the refrigerant in the second section. Therefore, the cooling amount of the desired portion can be made larger than the cooling amount of another portion, by corresponding the first section to the desired portion. This makes it possible to appropriately cool the entire first coil end.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view of a motor 1;

FIG. 2 is a side view of a stator 20 etc.;

FIG. 3 is a schematic sectional view taken along the line III-III shown in FIG. 1;

FIG. 4 is a partial enlarged sectional view taken along the line IV-IV shown in FIG. 2;

FIG. 5 is a schematic sectional view taken along the line V-V passing through a center plane CP shown in FIG. 1;

FIG. 6 is a schematic sectional view of the motor 1 according to a second embodiment at the same location as the line VI-VI shown in FIG. 1;

FIG. 7 is a schematic sectional view of the motor 1 according to a third embodiment at the same location as the line VII-VII shown in FIG. 1; and

FIG. 8 is a schematic sectional view of the motor 1 according to the third embodiment at the same location as the line VIII-VIII shown in FIG. 1.

### DETAILED DESCRIPTION OF EMBODIMENTS

In the motor according to the first aspect of the present disclosure, the first holes may be arranged asymmetrically with respect to a horizontal plane that passes through the axis of the stator core. The first holes may be arranged symmetrically with respect to a vertical plane that passes through the axis and that is orthogonal to the horizontal plane. The capacity of cooling the first coil end may differ between the refrigerant injected from the first holes located above the horizontal plane and the refrigerant injected from the first holes located below the horizontal plane. According to the above configuration, the arrangement density of the first holes can be made different between above and below the horizontal plane. This makes it possible to appropriately adjust the capacity of cooling the first coil end above and below the horizontal plane.

In the motor according to the first aspect of the present disclosure, the first section may be located above the second section in a vertical direction. The refrigerant injected from the first holes located above in the vertical direction has a longer contact time with the first coil end than the refrigerant injected from the first holes located below in the vertical direction. Accordingly, the cooling capacity may become high. According to the above configuration, the injection amount per unit area of the refrigerant in the above side can be made larger than the injection amount per unit area of the refrigerant in the below side. This makes it possible to improve the cooling efficiency.

In the motor according to the first aspect of the present disclosure, a part of the first coil end may be a specific region that. The specific region may generate more heat than a part of the first coil end other than the specific region. The first section may face the specific region in a radial direction. According to the above configuration, the injection amount per unit area of the refrigerant injected toward the specific region of the first coil end can be made larger than the injection amount per unit area of the refrigerant injected toward the part of the first coil end other than the specific region. This makes it possible to intensively cool the specific region.

In the motor according to the first aspect of the present disclosure, the first coil end may include a conductor member disposed over a partial range in a circumferential direction of the first coil end. The conductor member may be located in the specific region. According to the above configuration, the conductor member can be intensively cooled.

In the motor according to the first aspect of the present disclosure, the conductor member may include a neutral point connecting member that includes a neutral point of the coil. According to the above configuration, the neutral point of the coil can be intensively cooled.

In the motor according to the first aspect of the present disclosure, the conductor member may include a plurality of power lines that protrudes in the direction of the axis of the stator core from the first coil end. According to the above configuration, the power lines can be intensively cooled.

In the motor according to the first aspect of the present disclosure, the first coil end may include a first region and a second region. A space factor of the coil in the second region may be lower than a space factor of the coil in the first region. The specific region may include at least a part of the first region. According to the above configuration, the region with a high space factor of the coil can be intensively cooled.

In the motor according to the first aspect of the present disclosure, the first interval may be 75 percent or less of the second interval. According to the above configuration, the injection amount per unit area of the refrigerant from the first region can be appropriately made larger than the injection amount per unit area of the refrigerant from the second region.

The motor according to the first aspect of the present disclosure may further include a second annular member that provides sealing between a second end surface of the stator core and the inner wall surface of the housing, the second end surface being located on an opposite side of the first end surface of the stator core in the direction of the axis of the stator core. The second annular member may have a plurality of second holes configured to be passed through by a refrigerant that is injected toward a second coil end of the coil, the second coil end protruding from the second end surface of the stator core. According to the above configuration, both the first coil end and the second coil end can be appropriately cooled.

In the motor according to the first aspect of the present disclosure, the second holes may be arranged in a circumferential direction of the second annular member at regular intervals.

### First Embodiment

### Structure of Motor 1

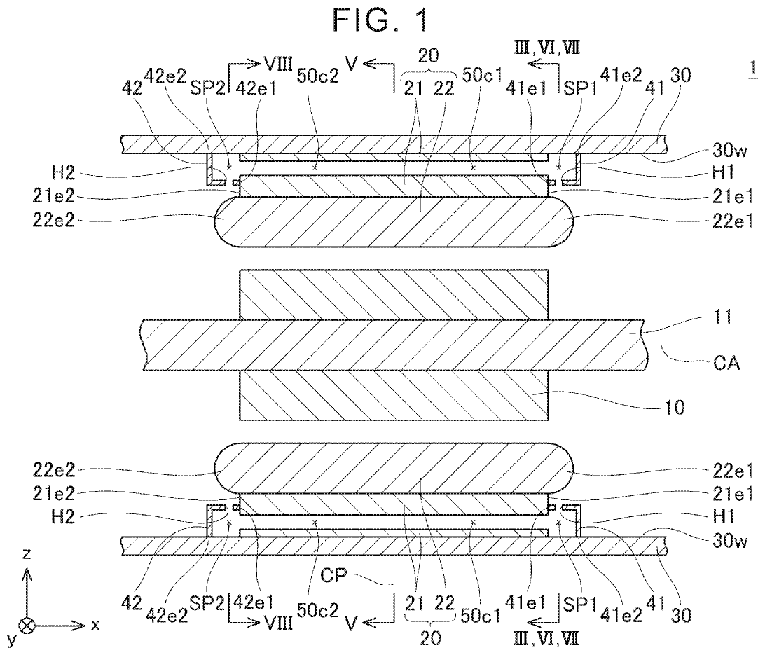

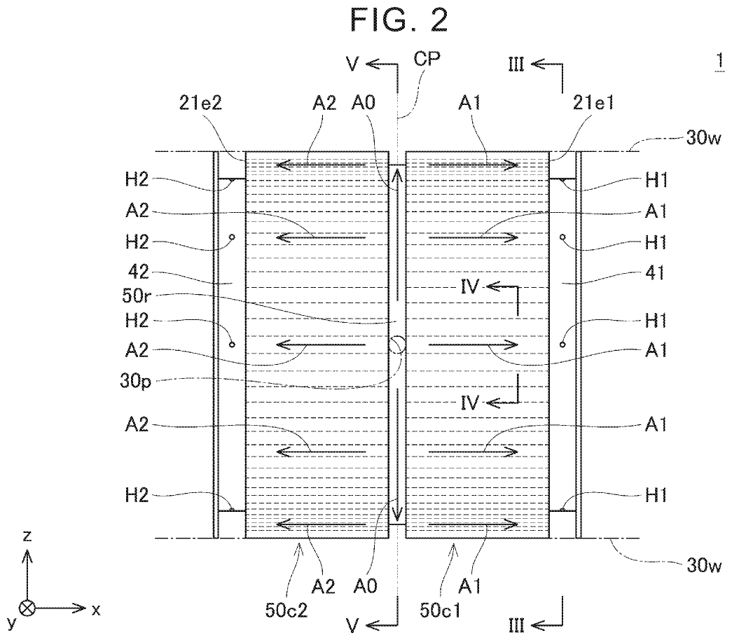

FIG. 1 shows a schematic sectional view of a motor 1 according to the present embodiment. FIG. 2 shows side views of a stator 20, a first annular member 41, and a second annular member 42. In FIG. 2, the illustration of a housing 30, a rotor 10, and a rotary shaft 11 is omitted, for the sake of clarity. Further, an inner wall surface 30w and a supply port 30p of the housing 30 are illustrated by imaginary lines. In FIGS. 1 and 2, the z-axis direction is the vertical direction, and the x-axis direction and the y-axis direction are the horizontal directions. The x-axis direction is the direction in which the rotary shaft 11 extends. The coordinate relationship is the same in subsequent figures.

The motor 1 is mounted on an electrified vehicle. Examples of the electrified vehicle include a hybrid electric vehicle and a battery electric vehicle. In the electrified vehicle, the motor 1 may be used as a traction motor that generates power for running the vehicle, or may be used as a generator that generates electric power using regenerative braking force and surplus engine power. In the electrified vehicle, the motor 1 is mounted so that the negative direction of the z-axis coincides with the direction of gravity.

As shown in FIG. 1, the motor 1 includes a center plane CP perpendicular to the rotary shaft 11. The center plane CP is a plane passing through the axial center of a stator core 21. The motor 1 includes a plane-symmetrical structure with respect to the center plane CP. Therefore, in the present specification, the structure etc. on the +x direction side with respect to the center plane CP will be mainly described hereinafter.

The motor 1 mainly includes the rotor 10, the stator 20, the housing 30, the first annular member 41, and the second annular member 42. The rotor 10 includes the rotary shaft 11. The rotary shaft 11 is supported by the housing 30 via a bearing (not shown), and is rotatable. The rotor 10 is adhered to the rotary shaft 11.

The stator 20 includes the stator core 21 and a coil 22. The stator core 21 is a substantially annular member made of a laminated steel plate or the like. A first end surface 21e1 is provided at one end in the axial direction (x direction) of the stator core 21, and a second end surface 21e2 is provided at the other end. A winding constituting the coil 22 are wound around the stator core 21. A first coil end 22e1 of the coil 22 protrudes in the axial direction from the first end surface 21e1. A second coil end 22e2 of the coil 22 protrudes in the axial direction from the second end surface 21e2.

The housing 30 is a member that houses the rotor 10 and the stator 20. The housing 30 covers the periphery of the stator 20. The supply port 30p that will be described later is provided on the side surface of the housing 30. Further, a cooling oil reservoir (not shown) is disposed at a bottom portion of the housing 30. Since a well-known related art can be used for the basic configuration of the housing 30, detailed explanation thereof is omitted here.

The first annular member 41 has a ring shape centering around the rotary shaft 11. The first annular member 41 is made of resin. As shown in FIG. 1, a first end portion 41e1 of the first annular member 41 is connected to the first end surface 21e1 of the stator core 21. A second end portion 41e2 of the first annular member 41 is connected to the inner wall surface 30w of the housing 30. Thereby, the first annular member 41 provides sealing between the first end surface 21e1 and the inner wall surface 30w. Various structures (e.g., seal groove) may be provided at the connecting portion between the first end portion 41e1 and the first end surface 21e1, and the connecting portion between the second end portion 41e2 and the inner wall surface 30w, to improve sealability. A space SP1 is provided between the first annular member 41 and the inner wall surface 30w. The space SP1 is a ring-shaped space centering around the rotary shaft 11. The first annular member 41 surrounds the periphery of the first coil end 22e1. In other words, the first annular member 41 faces the first coil end 22e1.

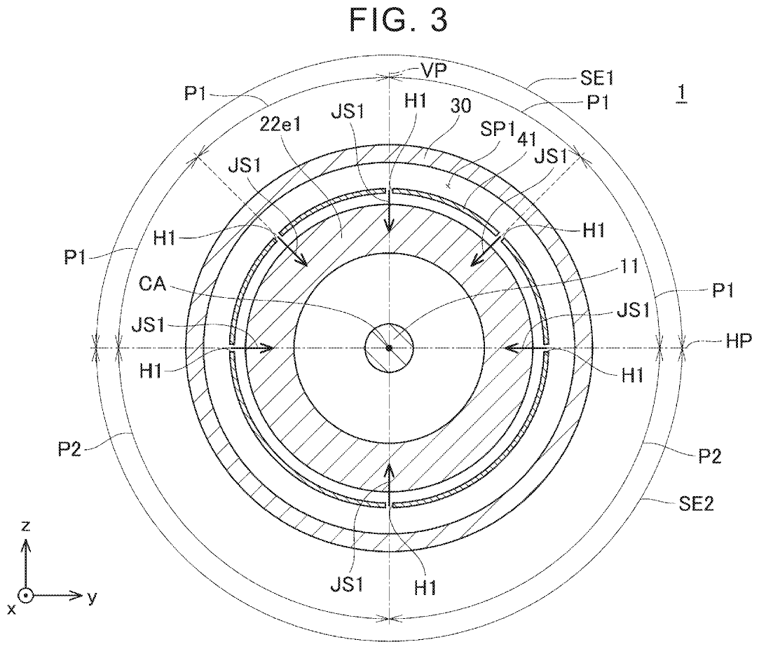

The first annular member 41 includes a plurality of first holes H1. The first holes H1 are holes for injecting cooling oil toward the first coil end 22e1. The first holes H1 will be described with reference to FIG. 3. FIG. 3 is a schematic sectional view taken along the line III-III shown in FIG. 1. FIG. 3 is a sectional view passing through the centers of the first holes H1. The first holes H1 pass through the first annular member 41 in the thickness direction. As shown in FIG. 3, the first holes H1 are arranged on the circumference. In the present embodiment, six first holes H1 are provided. The shape of the openings of the first holes H1 is circular. The first holes H1 all have the same opening area. In FIG. 3, the diameter of the first holes H1 is shown larger than the actual diameter, for the sake of clarity.

The first annular member 41 includes a first section SE1 and a second section SE2. The first section SE1 is a section in which at least two of the first holes H1 are arranged in the circumferential direction of the first annular member 41 at a first interval P1. The second section SE2 is a section in which at least two of the first holes H1 are arranged in the circumferential direction of the first annular member 41 at a second interval P2. The second interval P2 is larger than the first interval P1. Specifically, the first interval P1 is 75 percent or less of the second interval P2. As a result, the injection amount per unit area of cooling oil in the first section SE1 can be made larger than the injection amount per unit arca of cooling oil in the second section SE2.

In the present embodiment, the first section SE1 is located above the second section SE2 in the vertical direction (z direction in FIG. 3). Further, the length of the first interval P1 is ⅛ of that of the circumference. The length of the second interval P2 is ¼ of that of the circumference. Therefore, the first interval P1 is 50 percent of the second interval P2.

The stator core 21 includes a central axis CA. The central axis CA of the stator core 21 is common to the central axis of the rotary shaft 11. The stator core 21 also includes a horizontal plane HP passing through the central axis CA, and a vertical plane VP passing through the central axis CA. The horizontal plane HP and the vertical plane VP are orthogonal to each other. Further, the first holes H1 are arranged asymmetrically with respect to the horizontal plane HP, and are arranged symmetrically with respect to the vertical plane VP. As a result, the arrangement density of the first holes H1 can be made different between above and below the horizontal plane HP. In addition, the arrangement density of the first holes H1 can be made uniform in the right-left direction with respect to the vertical plane VP. Therefore, the cooling capacity of the first coil end 22e1 can be individually adjusted in the up-down direction with respect to the horizontal plane HP, and can be made the same in the right-left direction with respect to the vertical plane VP.

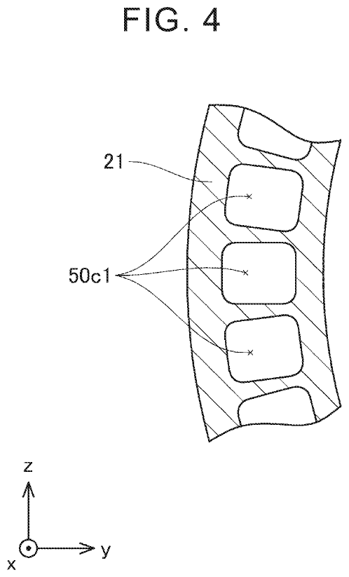

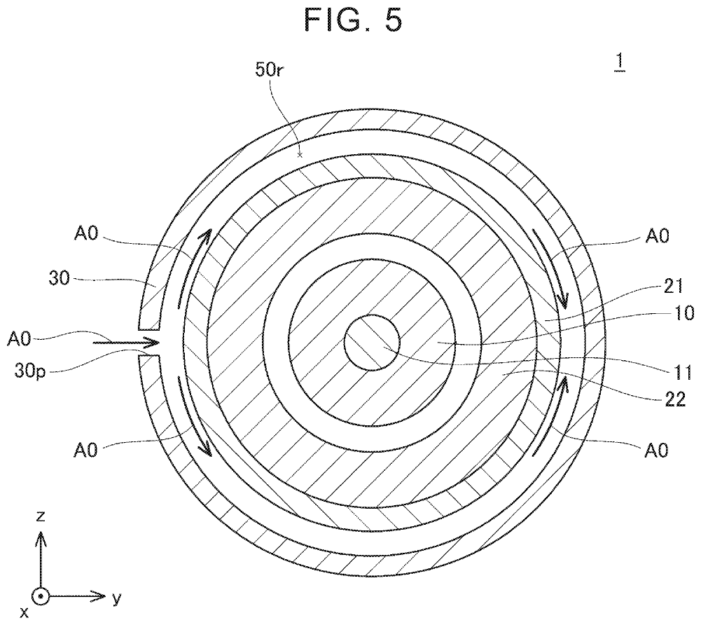

The stator core 21 will be described with reference to FIGS. 1, 2, 4, and 5. FIG. 4 is a partial enlarged sectional view taken along the line IV-IV shown in FIG. 2. FIG. 5 is a schematic sectional view taken along the line V-V passing through the center plane CP shown in FIG. 1. The stator core 21 is a cylindrical member. As shown in FIG. 2, the stator core 21 includes an annular channel 50r, a first channel 50cl, and a second channel 50c2.

As shown in FIG. 5, the annular channel 50r is a groove provided in the circumferential direction so as to go around the stator core 21 once. The upper surface of the annular channel 50r is open. A channel is provided by covering the open upper surface with the inner wall surface 30w. The annular channel 50r communicates with the supply port 30p of the housing 30.

Further, as shown in FIGS. 2 and 4, a plurality of the first channels 50cl is tunnel-shaped channel provided on the outer peripheral surface of the stator core 21. In FIG. 2, the first channels 50cl and a plurality of the second channels 50c2 are indicated by dotted lines. The first channels 50cl extend from the annular channel 50r to the first end surface 21e1 in the +x direction. The first channels 50cl extend parallel to each other and are arranged at regular intervals in the circumferential direction. Similarly, the second channels 50c2 have the same shape as the shape of the first channels 50c1. The second channels 50c2 extend from the annular channel 50r to the second end surface 21e2 in the −x direction.

The structure on the +x direction side with respect to the center plane CP has been mainly described above. The structure on the −x direction side with respect to the center plane CP is the same as the structure on the +x direction side with respect to the center plane CP. That is, the second annular member 42 is provided for sealing between the second end surface 21e2 of the stator core 21 and the inner wall surface 30w of the housing 30. A space SP2 is provided between the second annular member 42 and the inner wall surface 30w. The second annular member 42 includes a plurality of second holes H2. The second holes H2 are holes for injecting cooling oil toward the second coil end 22e2. The second annular member 42 includes a third section SE3 and a fourth section SE4. The third section SE3 is a section in which at least two of the second holes H2 are arranged in the circumferential direction at a third interval P3. The fourth section SE4 is a section in which at least two of the second holes H2 are arranged in the circumferential direction at a fourth interval P4 that is larger than the third interval P3. The contents of each of the third section SE3 and the fourth section SE4 are the same as the contents of the first section SE1 and the second section SE2 described with reference to FIG. 3. Therefore, the descriptions thereof will be omitted. Further, other descriptions of the structure on the −x direction side with respect to the center plane CP are omitted here.

### Operation

An operation of the motor 1 will be described. Cooling oil stored in the cooling oil reservoir flows into the supply port 30p of the housing 30 via a pump and a supply pipe (not shown). Cooling oil supplied to the supply port 30p flows into the annular channel 50r. The inflowing cooling oil flows circumferentially in the annular channel 50r (see arrows A0 in FIGS. 2 and 5). Cooling oil then flows into each of the first channels 50cl and flows in the +x direction (see arrows A1 in FIG. 2). At the same time, cooling oil flows into each of the second channels 50c2 and flows in the −x direction (see arrows A2 in FIG. 2). The cooling oil that has reached the +x direction end portions of the first channels 50cl is discharged into the space SP1 and reaches the first annular member 41. Similarly, the cooling oil that has reached the −x direction end portions of the second channels 50c2 is discharged into the space SP2 and reaches the second annular member 42.

The injection state of cooling oil will be described with reference to FIG. 3. Since the space SP1 is completely filled with cooling oil, pressure is applied to the cooling oil. As shown in FIG. 3, cooling oil is injected from each of the first holes H1 toward the first coil end 22e1. In FIG. 3, the flow rate of cooling oil injected from the first holes H1 is indicated by vectors JS1. All of the vectors JS1 have the same magnitude.

### Effect

The cooling oil injected from the first holes H1 located above in the vertical direction has a longer drop distance to the cooling oil reservoir than the cooling oil injected from the first holes H1 located below in the vertical direction. Therefore, the cooling oil injected from the first holes H1 located above in the vertical direction has a longer contact time with the first coil end 22e1. Accordingly, the cooling capacity may become high. In the technique of the present embodiment, the first section SE1 is located vertically above the second section SE2. As a result, the injection amount per unit area of cooling oil from the above side can be made larger than the injection amount per unit area of cooling oil from the below side. This makes it possible to improve the cooling efficiency. Since the second holes H2 of the second annular member 42 include the same structure as the structure of the first holes H1, the same effect can be obtained.

### Second Embodiment

Configuration of First Holes H201 and Second Holes H₂O₂

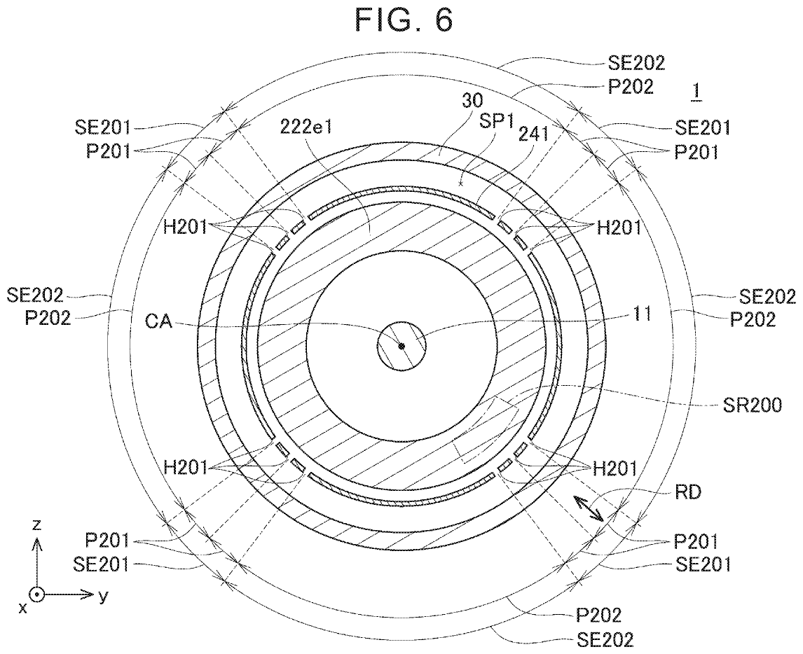

A second embodiment differs from the first embodiment in an arrangement mode of a plurality of first holes H201 and a plurality of second holes H202. Configurations common to the second embodiment and the first embodiment are denoted by the common reference signs, and the descriptions thereof will be omitted. Further, configurations specific to the second embodiment are distinguished by showing the configurations with reference signs in the 200s. FIG. 6 shows a schematic sectional view of the motor 1 according to the second embodiment. FIG. 6 is a sectional view of the motor 1 according to the second embodiment at the same location as the line VI-VI shown in FIG. 1 of the first embodiment.

A first annular member 241 includes a first section SE201 and a second section SE202. The first section SE201 is a section in which the first holes H201 are arranged in the circumferential direction at a first interval P201. The second section SE202 is a section in which the first holes H201 are arranged in the circumferential direction at a second interval P202. The second interval P202 is larger than the first interval P201. The first interval P201 is 75 percent or less of the second interval P202. In the present embodiment, four first sections SE201 are provided. Further, the first sections SE201 are arranged in fourfold symmetry with respect to the central axis CA.

A part of a first coil end 222e1 includes a specific region SR200. The specific region SR200 is a region that generates more heat than another portion of the first coil end 222e1. In FIG. 6, the specific region SR200 is indicated by a long dashed short dashed line. A specific example of the specific region SR200 will be described later.

At least one of the first sections SE201 faces the specific region SR200 in a radial direction RD. Here, the radial direction RD is the radial direction of a circle with the central axis CA as the center. In the present embodiment, the first section SE201 located at the lower right in FIG. 6 faces the specific region SR200 in the radial direction RD. Further, the other three of the first sections SE201 do not face the specific region SR200. The second holes H₂O₂ of a second annular member 242 also include the same structure as the structure of the first holes H201 described above. Therefore, detailed description is omitted.

### Effect

With the technique of the present embodiment, the first section SE201 can be disposed so as to correspond to the specific region SR200. The injection amount per unit area of cooling oil injected toward the specific region SR200 can be made larger than the injection amount per unit area of cooling oil injected toward another portion in the first coil end 222e1. This makes it possible to intensively cool the specific region SR200.

### Third Embodiment

### Configuration of First Holes H301 and Second Holes H302

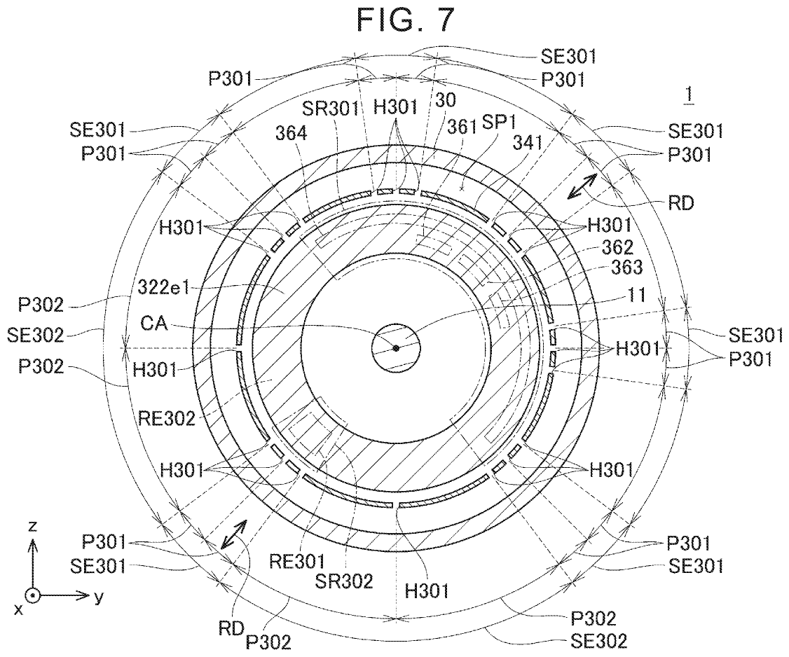

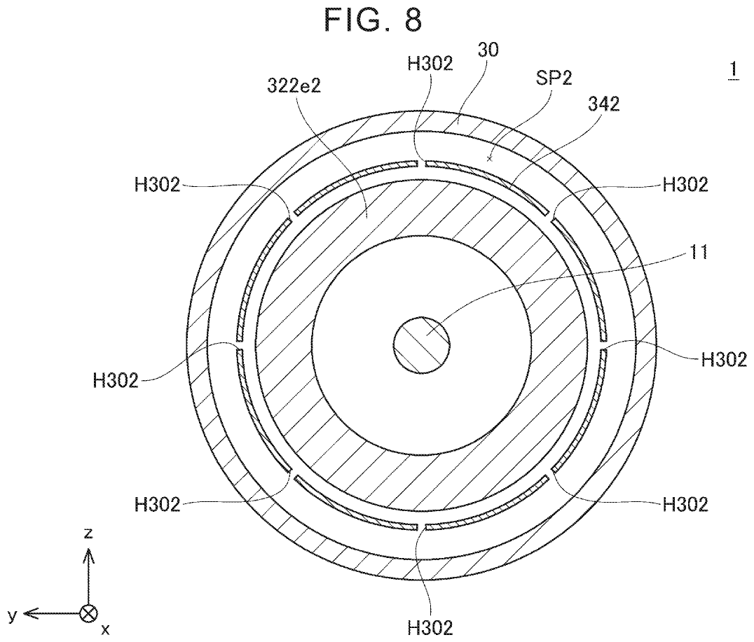

A third embodiment differs from the first and second embodiments in an arrangement mode of a plurality of first holes H301 and a plurality of second holes H302. Configurations common to the third embodiment and the first embodiment are denoted by the common reference signs, and the descriptions thereof will be omitted. Further, configurations specific to the third embodiment are distinguished by showing the configurations with reference signs in the 300s. FIGS. 7 and 8 shows a schematic sectional view of the motor 1 according to the third embodiment. FIG. 7 is a sectional view of a first annular member 341 at the same location as the line VII-VII shown in FIG. 1. FIG. 8 is a sectional view of a second annular member 342 at the same location as the line VIII-VIII shown in FIG. 1.

The structures of a first coil end 322e1 and the first annular member 341 will be described with reference to FIG. 7. The first coil end 322e1 includes a first region RE301 and a second region RE302. The first region RE301 is a region with a high space factor of the coil. The second region RE302 is a region with a space factor of the coil lower than that of the first region RE301. That is, a region other than the first region RE301 correspond to the second region RE302.

A part of the first coil end 322e1 includes specific regions SR301, SR302. The specific regions SR301, SR302 are regions that generate more heat than another portion of the first coil end 322e1. Power lines 361 to 363 and a neutral point connecting member 364 are arranged in the specific region SR301. The power lines 361 to 363 and the neutral point connecting member 364 are made of a conductor member such as metal. The conductor members are arranged over a partial range in the circumferential direction of the first coil end 322e1. The first region RE301 is included in the specific region SR302. In FIG. 7, the specific region SR301, the power lines 361 to 363, the neutral point connecting member 364, and the first region RE301 are indicated by long dashed short dashed lines.

The power lines 361 to 363 are lead wires respectively connected to one ends of phase coils of U. V. and W-phases. The power lines 361 to 363 protrude in the axial direction (+x direction) from the first coil end 322e1. The power lines 361 to 363 may be bus bars. The neutral point connecting member 364 is a member that connects the other ends of the respective phase coils. That is, the neutral point connecting member 364 is a member including a neutral point of the coil 22. The neutral point connecting member 364 may be a circular-arc bus bar.

The first annular member 341 includes a first section SE301 and a second section SE302. The first section SE301 is a section in which the first holes H301 are arranged in the circumferential direction of the first annular member 341 at a first interval P301. The second section SE302 is a section in which the first holes H301 are arranged in the circumferential direction of the first annular member 341 at a second interval P302. The second interval P302 is larger than the first interval P301. The first interval P301 is 75 percent or less of the second interval P302. The first section SE301 faces the specific regions SR301, SR302 in the radial direction RD.

The structures of a second coil end 322e2 and the second annular member 342 will be described with reference to FIG. 8. The second coil end 322e2 does not include the power lines 361 to 363 and a neutral point connecting member. That is, since the second coil end 322e2 does not include a specific region, the amount of generated heat is less than that of the first coil end 322e1.

The second annular member 342 includes the second holes H302. The second holes H302 are arranged at regular intervals in the circumferential direction of the second annular member 342. In the present embodiment, eight second holes H302 are arranged at regular intervals on the circumference of the second annular member 342.

### Effect

The temperature distribution width of the first coil end 322e1 may become larger due to the power lines 361 to 363, the neutral point connecting member 364, and the first region RE301 that generate a large amount of heat. With the technique of the present embodiment, the region with a large amount of generated heat can be intensively cooled by the first section SE301. This makes it possible to suppress the temperature distribution width of the first coil end 322e1.

In the second coil end 322e2 in which the power lines 361 to 363, the neutral point connecting member 364, etc. that generate a large amount of heat are not included, the temperature distribution width is smaller than that of the first coil end 322e1. In the technique of the present embodiment, the second holes H302 are arranged at regular intervals circumferentially in the second annular member 342. As a result, the second coil end 322e2 can be cooled substantially uniformly in the circumferential direction. This makes it possible to appropriately adjust the cooling capacity of the first coil end 322e1 and the cooling capacity of the second coil end 322e2 according to the temperature distribution width.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

### Modification

The shape of the openings of the first hole and the second hole is not limited to a circle, and can be various shapes. Further, the number and the arrangement of the first hole and the second hole are not limited to the modes of the present specification, and can take various modes.

In the first embodiment, the lower the first holes H1 are located in the vertical direction, the more difficult it may be to obtain the cooling effect. This is because the injection velocity component in the direction against the gravity direction increases. Therefore, the position of the first section SE1 in the vertical direction (z direction in FIG. 3) may be set below the second section SE2. As a result, the injection amount per unit area of cooling oil from the below side can be made larger than the injection amount per unit area of cooling oil from the above side. This makes it possible to increase the cooling capacity on the vertically below side.

What is claimed is:

1. A motor comprising:
a rotor;
a stator that includes a stator core and a coil;
a housing that houses the rotor and the stator; and
a first annular member that provides sealing between a first end surface of the stator core in a direction of an axis of the stator core and an inner wall surface of the housing, wherein
the first annular member has a plurality of first holes configured to be passed through by a refrigerant that is injected toward a first coil end of the coil, the first coil end protruding from the first end surface of the stator core, and
the first annular member includes a first section in which at least two of the first holes are arranged in a circumferential direction of the first annular member at a first interval, and a second section in which at least two of the first holes are arranged in the circumferential direction of the first annular member at a second interval that is larger than the first interval.

2. The motor according to claim 1, wherein the first holes are arranged asymmetrically with respect to a horizontal plane that passes through the axis of the stator core, and are arranged symmetrically with respect to a vertical plane that passes through the axis and that is orthogonal to the horizontal plane.

3. The motor according to claim 2, wherein the first section is located above the second section in a vertical direction.

4. The motor according to claim 1, wherein:
a part of the first coil end is a specific region;
the specific region generates more heat than a part of the first coil end other than the specific region; and
the first section faces the specific region in a radial direction.

5. The motor according to claim 4, wherein:
the first coil end includes a conductor member disposed over a partial range in a circumferential direction of the first coil end; and
the conductor member is located in the specific region.

6. The motor according to claim 5, wherein the conductor member includes a neutral point connecting member that includes a neutral point of the coil.

7. The motor according to claim 5, wherein the conductor member includes a plurality of power lines that protrudes in the direction of the axis of the stator core from the first coil end.

8. The motor according to claim 4, wherein:
the first coil end includes a first region and a second region;
a space factor of the coil in the second region is lower than a space factor of the coil in the first region; and
the specific region includes at least a part of the first region.

9. The motor according to claim 1, wherein the first interval is 75 percent or less of the second interval.

10. The motor according to claim 1, further comprising a second annular member that provides sealing between a second end surface of the stator core and the inner wall surface of the housing, the second end surface being located on an opposite side of the first end surface of the stator core in the direction of the axis of the stator core, wherein the second annular member has a plurality of second holes configured to be passed through by a refrigerant that is injected toward a second coil end of the coil, the second coil end protruding from the second end surface of the stator core.

11. The motor according to claim 10, wherein the second holes are arranged in a circumferential direction of the second annular member at regular intervals.
